(19) United States
(12) Patent Application Publication
(10) Pub. No.: US 2006/0248989 A1
(43) Pub. Date: Nov. 9, 2006

(54) Tool for removing toilet seat

(76) Inventors: Joseph C. Duffey, Alexandria, LA (US); Joseph L. Duffey, Alexandria, LA (US)

Correspondence Address: JAMES RAY & ASSOCIATES, 2640 PITCAIRN RAOD, MONROEVILLE, PA, 15146, US

(21) Appl. No.: 11/429,788

(22) Filed: May 8, 2006

Related U.S. Application Data
(60) Provisional application No. 60/678,630, filed on May 6, 2005.

(51) Int. Cl. B25B 13/48; B25B 13/56

(52) U.S. Cl. 81/176.15

(57) ABSTRACT

An apparatus for at least one of removing, repairing and replacing a toilet bowl seat comprising an elongated tubular type member having each of a predetermined configuration and a predetermined length. There is at least one pair of radially opposed wedge shaped slots formed in a sidewall portion of such elongated tubular type member adjacent a predetermined end thereof for engaging wing nuts. Such slots having a predetermined length and a wedge shaped which is wider adjacent the predetermined end of such elongated tubular type member. At least one predetermined fitting is engageable at a second end of such elongated tubular type member and having a predetermined configuration for engaging nut heads.

### CROSS-REFERENCE TO RELATED APPLICATION

This application is closely related to and claims priority from Provisional Patent Application Ser. No. 60/678,630 filed May 6, 2005.

### FIELD OF THE INVENTION

The present invention relates, in general, to tools and, more particularly, this invention relates to a tool for removing and replacing the nuts from a toilet seat.

### BACKGROUND OF THE INVENTION

Prior to the conception and development of the present invention, as is generally well known in the art, the bolts and nuts holding a toilet seat to the stool become corroded and must be replaced periodically. These nuts and bolts can be made from hard plastic which can be cracked or metal which will corrode over time.

Changing a toilet bowl seat is a rather unpleasant task and requires the use of either pliers or wrenches. As is also well known there is usually limited space between a wall and the bowl in which to operate and this adds to the frustration in replacing a toilet bowl seat when necessary.

Another problem encountered in working on present day toilet seats is the number of different style fastening systems used by the manufacturers of these seats.

### SUMMARY OF THE INVENTION

The present invention provides an apparatus for at least one of removing, repairing and replacing a toilet bowl seat. Such apparatus includes an elongated tubular type member having each of a first predetermined configuration and a first predetermined length. The elongated tubular type member is formed from a first predetermined material. There is at least one pair of radially opposed wedge shaped slots formed in a sidewall portion of such elongated tubular type member adjacent a first predetermined end thereof for engaging wing nuts. These wedge shaped slots have a second predetermined length and they are wider adjacent the first predetermined end of such elongated tubular type member. There is also at least one predetermined fitting engageable at a second end of such elongated tubular type member which has a second predetermined configuration for engaging nut heads. The at least one predetermined fitting is formed from a second predetermined material.

### OBJECTS OF THE INVENTION

It is, therefore, one of the primary objects of the present invention to provide a tool for replacing a toilet bowl seat which is easy to use.

Another object of the present invention is to provide a tool for replacing a toilet bowl seat which is relatively inexpensive to produce.

Still another object of the present invention is to provide a tool for replacing a toilet bowl seat which will save time and energy.

Yet another object of the present invention is to provide a tool for replacing a toilet bowl seat which is relatively lightweight.

An additional object of the present invention is to provide a tool for replacing a toilet bowl seat which can be used on a variety of seat designs.

In addition to the several objects and advantages of the present invention which have been described with some degree of specificity above it should be understood that various additional objects and advantages of the invention will become more readily apparent to those persons who are skilled in the relevant art from the following more detailed description of the invention when such description is taken in conjunction with the attached drawing figures and with the appended claims.

### BRIEF DESCRIPTION OF THE DRAWINGS

FIG. 1 is a perspective view showing in particular one end of an apparatus of the present invention that is engageable with hex nuts used for securing a toilet seat onto a toilet bowl;

FIG. 1A is a cross-sectional view of the one end of the apparatus, illustrated in FIG. 1, showing the recess formed in such end for seating against the hex nut;

FIG. 2 is an exploded perspective view showing in particular the other end of the inventive apparatus that is engageable with plastic winged nuts used for securing a toilet seat onto a toilet bowl; and

FIG. 3 is a partial side elevation view particularly showing the one end of the apparatus having the recess for engaging the hex nut being used to secure the toilet seat onto the toilet bowl.

### BRIEF DESCRIPTION OF THE PRESENTLY PREFERRED AND VARIOUS ALTERNATIVE EMBODIMENTS OF THE INVENTION

Prior to proceeding to the more detailed description of the invention, it should be noted that, for the sake of clarity, identical components, having identical functions have been identified with identical reference numerals throughout the several drawing figures.

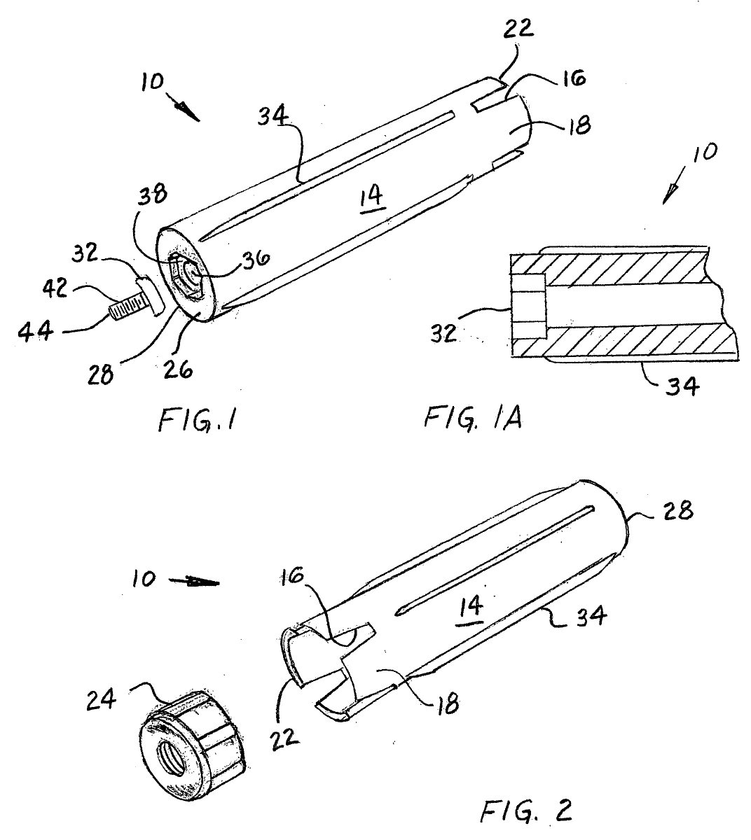

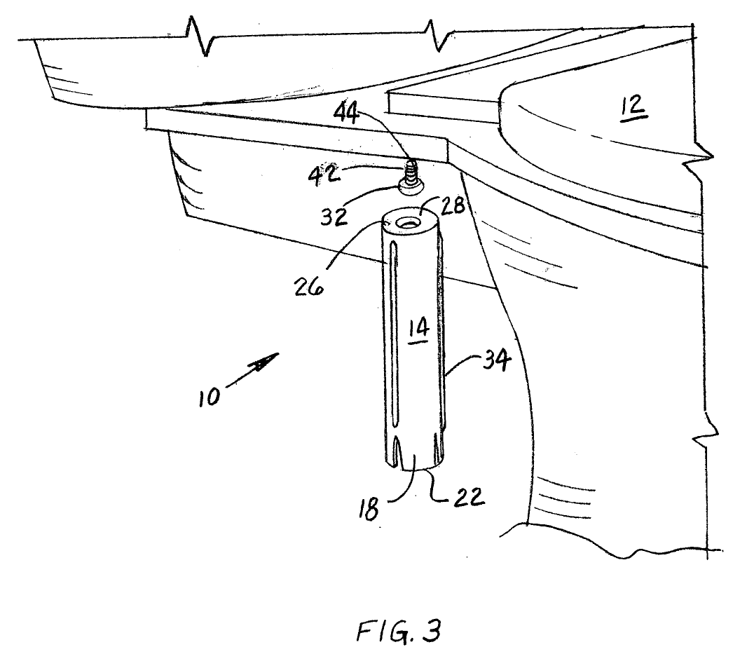

Referring now, more particularly, to FIGS. 1-3 of the drawings, there is illustrated an apparatus, generally designated 10, that aids in at least one of removing, repairing and replacing a toilet bowl seat 12. The apparatus 10 includes an elongated tubular type member 14 that has each of a first predetermined configuration and a first predetermined length. The elongated tubular type member 14 is formed from a first predetermined material.

The apparatus 10 also has at least one pair of radially opposed wedge shaped slots 16 formed in a sidewall portion 18 of the elongated tubular type member 14 adjacent a first predetermined end 22 thereof for engaging wing nuts 24. These slots 16 have a second predetermined length and are wider adjacent such first predetermined end 22 of the elongated tubular type member 14.

Such apparatus 10 also includes at least one predetermined fitting 26 engageable with a second end 28 of elongated tubular type member 14. Such at least one predetermined fitting 26 has a second predetermined configuration for engaging nut heads 32 and is formed from a second predetermined material.

In a presently preferred embodiment, the apparatus 10 further includes a predetermined plurality of rib members 34 disposed on the outer sidewall 18 of the elongated tubular type member 14 for improved gripping ability. Each of the predetermined plurality of ribs 34 has each of a third predetermined length, a predetermined width, a third predetermined configuration and a predetermined height.

The configuration of such elongated tubular type member 14 can either be cylindrical, rectangular, or hexagonal. However, the most presently preferred configuration would be cylindrical. Also, the length of such elongated tubular type member 14 is, preferably, between about six inches and about ten inches.

In another presently preferred embodiment, the apparatus 10 will have two pairs of radially opposed wedge shaped slots 16 formed in the sidewall portion 18 of such elongated tubular type member 14 adjacent the first predetermined end 22 thereof.

In another presently preferred embodiment, the apparatus 10 will include two predetermined fittings engageable at the second end 28 of such elongated tubular type member 14. A first one 26 of the two predetermined fittings has the second predetermined configuration for engaging nut heads 32 and is formed from the second predetermined material, and a second one (not shown) of the two predetermined fittings has a fourth predetermined configuration for engaging nut heads (not shown) and is formed from a third predetermined material.

The first predetermined material used to make the elongated tubular type member 14 and the second predetermined material used to make the at least one predetermined fitting 26 are selected from the group consisting of plastic and metal. In addition, the first and second predetermined materials can be either identical or different.

The presently preferred types of metal that can be used to make the first predetermined material and the second predetermined material are selected from the group consisting of aluminum and steel. The most preferred type of metal to use is aluminum.

However, in the most presently preferred embodiment of the apparatus 10, the first predetermined material and the second predetermined material will be plastic.

Finally, as best seen in FIG. 1, the at least one predetermined fitting 26, preferably, includes an aperture 36 formed through at least a portion of a bottom wall 38 thereof for receiving a shaft 42 of a bolt 44 therethrough.

While the presently preferred and various alternative embodiments of the invention have been discussed in considerable detail above, it should be obvious to those persons who are skilled in the art that various modifications and adaptations of the present invention can be made without departing from the spirit of the invention and the scope of the appended claims.

We claim:

1. An apparatus for at least one of removing, repairing and replacing a toilet bowl seat, said apparatus comprising:
(a) an elongated tubular type member having each of a first predetermined configuration and a first predetermined length, said elongated tubular type member being formed from a first predetermined material;
(b) at least one pair of radially opposed wedge shaped slots formed in a sidewall portion of said elongated tubular type member adjacent a first predetermined end thereof for engaging wing nuts, said slots having a second predetermined length, said wedge shaped slots being wider adjacent said first predetermined end of said elongated tubular type member; and
(c) at least one predetermined fitting engageable at a second end of said elongated tubular type member and having a second predetermined configuration for engaging nut heads, said at least one predetermined fitting being formed from a second predetermined material.

2. An apparatus for removing and replacing a toilet bowl seat, according to claim 1, wherein said apparatus further includes a predetermined plurality of rib members disposed on an outer sidewall of said elongated tubular type member for improved gripping ability, each of said predetermined plurality of ribs having each of a third predetermined length, a predetermined width, a third predetermined configuration and a predetermined height.

3. An apparatus for removing and replacing a toilet bowl seat, according to claim 1, wherein said first predetermined configuration of said elongated tubular type member is selected from cylindrical, rectangular and hexagonal.

4. An apparatus for removing and replacing a toilet bowl seat, according to claim 3, wherein said first predetermined configuration of said elongated tubular type member is cylindrical.

5. An apparatus for removing and replacing a toilet bowl seat, according to claim 1, wherein said first predetermined length of said elongated tubular type member is between about six inches and about ten inches.

6. An apparatus for removing and replacing a toilet bowl seat, according to claim 1, wherein said apparatus includes two pairs of radially opposed wedge shaped slots formed in said sidewall portion of said elongated tubular type member adjacent said first predetermined end thereof.

7. An apparatus for removing and replacing a toilet bowl seat, according to claim 1, wherein said apparatus includes two predetermined fittings engageable at said second end of said elongated tubular type member, a first of said two predetermined fittings having said second predetermined configuration and being formed from said second predetermined material and a second of said two predetermined fittings having a fourth predetermined configuration and being formed from a third predetermined material.

8. An apparatus for removing and replacing a toilet bowl seat, according to claim 1, wherein said first predetermined material and said second predetermined material are selected from a group consisting of plastic and metal.

9. An apparatus for removing and replacing a toilet bowl seat, according to claim 8, wherein said first predetermined material and said second predetermined material are identical.

10. An apparatus for removing and replacing a toilet bowl seat, according to claim 8, wherein said first predetermined material and said second predetermined material are different.

11. An apparatus for removing and replacing a toilet bowl seat, according to claim 1, wherein said first predetermined material and said second predetermined material are selected from a group consisting of aluminum and steel.

12. An apparatus for removing and replacing a toilet bowl seat, according to claim 11, wherein said first predetermined material and said second predetermined material are aluminum.

13. An apparatus for removing and replacing a toilet bowl seat, according to claim 8, wherein said first predetermined material and said second predetermined material are plastic.

14. An apparatus for removing and replacing a toilet bowl seat, according to claim 1, wherein said at least one predetermined fitting engageable at said second end of said elongated tubular type member includes an aperture formed through at least a portion of a bottom wall thereof for receiving a shaft of a bolt therethrough.
